(19) United States
(12) Patent Application Publication
(10) Pub. No.: US 2023/0025001 A1
(43) Pub. Date: Jan. 26, 2023

(54) Portable Bean Bag Game

(71) Applicant: Brendan Spillane, Novato, CA (US)

(72) Inventor: Brendan Spillane, Novato, CA (US)

(21) Appl. No.: 17/486,811

(22) Filed: Sep. 27, 2021

Related U.S. Application Data
(60) Provisional application No. 63/224,063, filed on Jul. 21, 2021.

(51) Int. Cl. A63B 67/06; A63B 63/08; A47G 9/06

(52) U.S. Cl. CPC A63B 67/06; A63B 63/08; A47G 9/062; A63B 2067/061; A63B 2210/50; B67B 7/16

(57) ABSTRACT

A portable system with bean bags that can be used for playing games or as a towel. The playing surface can be constructed of a flexible, rollable material, such as a fabric used for towels. Games can be played by players tossing the bags toward holes on opposite ends of a playing surface. Nets can be placed in the holes and attached to the playing surface. When a user wants to use the system as a towel rather than a game, the bags can be stored in a storage pouch. The system can include stake holes for placing stakes into the ground to secure the playing surface. The system can further include a carry pouch for storing and transporting the playing surface. The playing surface can easily be rolled up and placed in the carry pouch.

### CROSS-REFERENCE TO RELATED APPLICATIONS

This is a Nonprovisional Utility U.S. Patent Application under 37 CFR 1.53(b) claiming priority to U.S. Provisional Patent Application No. 63,224,063, filed Jul. 21, 2021.

### BACKGROUND OF THE INVENTION

### 1. Field of the Invention

The present invention relates generally to bean bag games. More particularly, the present invention relates to a portable bean bag game that can also function as a towel.

### 2. Description of Related Art

Cornhole and other bean bag toss games are traditionally played with large and bulky playing boards. Cornhole is not a readily portable game because it requires two playing boards that are heavy and occupy a lot of space. Cornhole is a very popular game that people play in backyards or at the beach. When people travel for leisure and recreation, it is desirable to pack lightly. Airplanes have restrictions on weight and sizes of luggage. Vehicles have limited capacity for luggage which requires travelers to wisely choose the items to pack. When people walk to the beach, they often carry several items at one time. Games that are bulky are often too cumbersome for people to transport on trips such as travelling to the beach. Thus, there is a need for a portable bean bag game that is small, lightweight, and can also be used as a towel.

### SUMMARY OF THE INVENTION

A portable system with bean bags that can be used for playing games or as a towel is disclosed herein. The playing surface can be constructed of a flexible, rollable material, such as a fabric used for towels. Games can be played by players tossing the bags toward holes on opposite ends of a playing surface. Nets can be placed in the holes and attached to the playing surface. The nets can be used to capture and hold bags but can also be used to hold ice, beverages, and other items.

The playing surface can also be used as a towel for a user to sit or lay on. When a user wants to use the system as a towel rather than a game, the bags can be stored in a storage pouch. The storage pouch filled with bags can be used as a comfortable pillow for a user to rest on. The system can also include a plurality of stake holes for placing stakes into the ground to secure the playing surface. The system can further include a carry pouch for storing and transporting the playing surface. The playing surface can easily be rolled up and placed in the carry pouch. The carry pouch can include a handle enabling a user to readily carry the system by hand or over the user's shoulder.

These and other features and advantages will be apparent from reading of the following detailed description and review of the associated drawings. It is to be understood that both the forgoing general description and the following detailed description are explanatory and do not restrict aspects as claimed.

### BRIEF DESCRIPTION OF THE DRAWINGS

FIG. 1 illustrates a perspective view of a system including a playing surface and a plurality of bags.

FIG. 2 illustrates a side view of the system including the playing surface and bags.

FIG. 3 illustrates a cross-sectional view of the system showing storage compartments and a storage pouch.

FIG. 4 illustrates a cross-sectional view of the system showing an example use of the attached storage pouch.

FIG. 5 illustrates a carry pouch for storing and transporting the system.

FIG. 6 illustrates a perspective view of an apparatus without showing the bags used for games.

FIG. 7 illustrates a right side view of the apparatus.

FIG. 8 illustrates a left side view of the apparatus.

FIG. 9 illustrates a front view of the apparatus.

FIG. 10 illustrates a rear view of the apparatus.

FIG. 11 illustrates a top view of the apparatus.

FIG. 12 illustrates a bottom view of the apparatus.

### DETAILED DESCRIPTION OF EMBODIMENTS

The following descriptions relate principally to preferred embodiments while a few alternative embodiments may also be referenced on occasion, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more. Thus, in the context of this specification, the term “comprising” is used in an inclusive sense and thus should be understood as meaning “including, but not limited to.” As used herein, the use of “may” or “may be” indicates that a modified term is appropriate, capable, or suitable for an indicated capacity, function, or usage, while considering that in some circumstances the modified term may sometimes not be appropriate, capable, or suitable. “Plurality” is defined as more than one when used to describe a quantity in the description and claims.

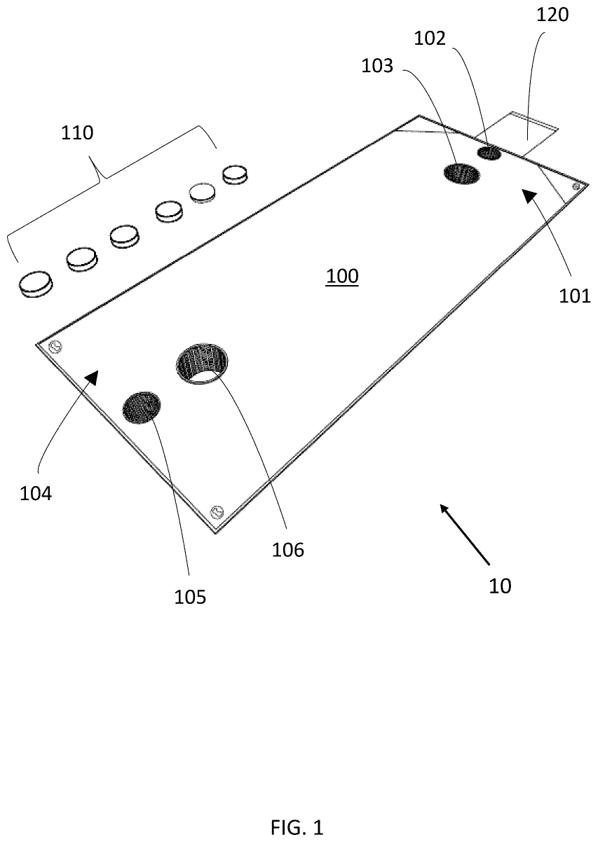

FIG. 1 illustrates a perspective view of a system 10 including a playing surface 100 and a plurality of bags 110. The system 10 is portable and can be used for playing games or as a beach towel. The playing surface 100 is shown in an unrolled position and includes a plurality of holes. The playing surface 100 can be constructed of a flexible, rollable material, such as a fabric used for towels. The holes can be various sizes and are preferably circular or oval-shaped. In the example system 10, a first hole 102 and a second hole 103 are located at a first end 101 of the playing surface 100. A third hole 105 and a fourth hole 106 are located at a second end 104 of the playing surface 100. Alternatively, the playing surface 100 can include more or less holes of different sizes.

The bags 110 are cylindrical in shape in the example system 10 but can be a variety of shapes including spherical, triangular, rectangular, etc. In the example shown, a bag 110 can be round and shaped like a puck. The size of the bag 110 can vary with different diameters, lengths, heights, etc. In one example, a bag 110 can have a five inch diameter, and a one inch height. The bag 110 can be filled with materials such as lentils, rice, feed corn, sand, dried lavender, beads, and the like.

Games can be played by players tossing the bags 110 toward the holes on the playing surface 100. For example, a first player can have a plurality of bags 110 and stand at a first end 101 of the playing surface 100. The first player can throw bags 110 at the holes at the second end 104 with the intention of landing the bags in the holes. The second player can throw bags 100 at the holes at the first end 101. The players can alternate throwing bags back and forth toward opposite ends. The holes can be various sizes and distances apart to increase or decrease difficulty. Players can decide on other rules and scoring to determine the winners of games.

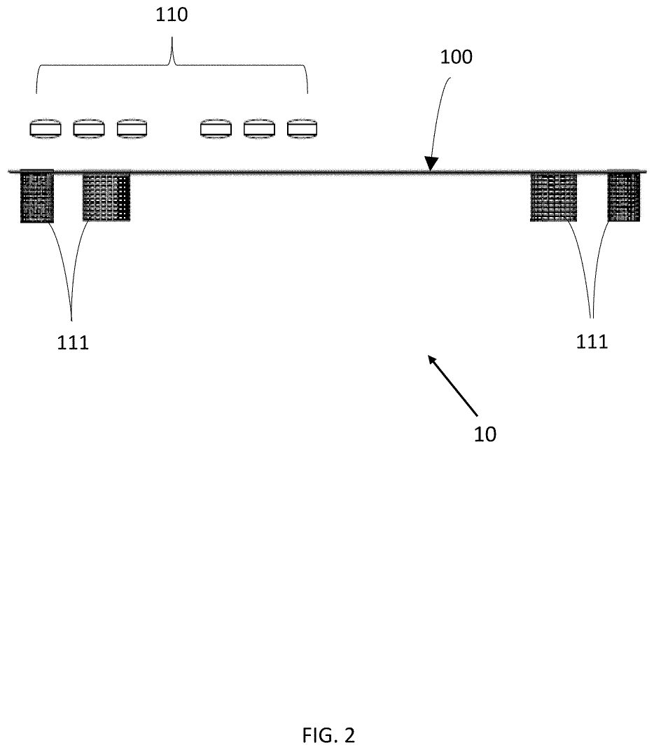

FIG. 2 illustrates a side view of the system 10 including the playing surface 100 and bags 110. A plurality of nets 111 can be placed in the plurality of holes and affixed to the playing surface 100. The nets 111 are preferably constructed of a flexible mesh or other threaded material. The nets 111 can be expanded when the system 10 is in use or compress when the system 10 is rolled up for storage or transport. The nets 111 can be used to capture and hold bags 110 but can also be used to hold ice, beverages, and other items. Alternatively, the nets 111 can be constructed of another flexible material such as plastic. When the playing surface 100 is placed on a soft surface such as beach sand, the sand can be displaced by a user so that the nets 111 can be expanded to full length, as shown in FIG. 2. The system 10 can also be used on a hard surface (e.g. yard, concrete) with the expanded nets 111 in contact with the hard surface which elevates the playing surface 100 above.

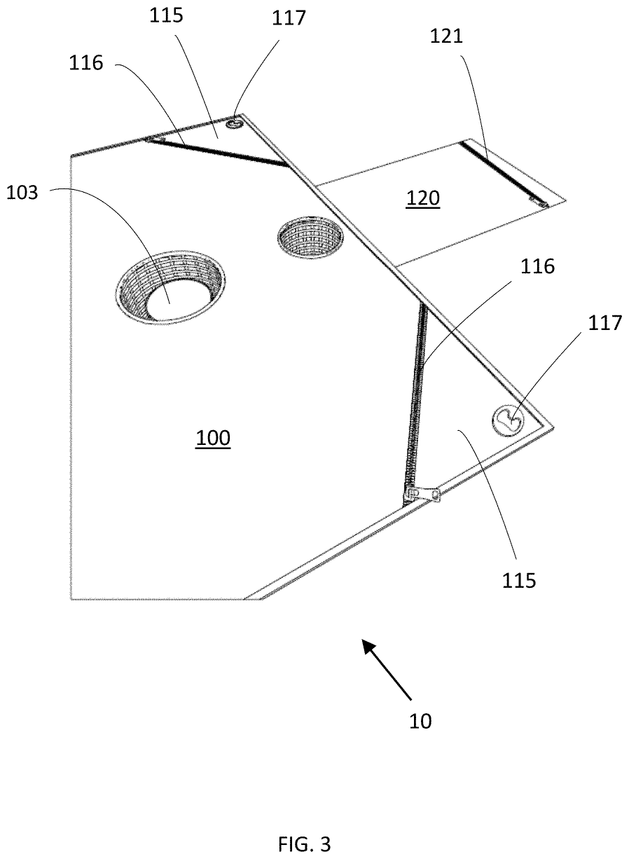

FIG. 3 illustrates a cross-sectional view of the system 10 showing storage compartments 115 and a storage pouch 120. In this example, there are two storage compartments 115 located at the corners of the first end 101 of the playing surface. The system 10 can employ any number of compartments (e.g. zero, one, two, three, four). For example, the system 10 can also have compartments 115 located at the second end 104 of the playing surface. A storage compartment 115 can be closed using a zipper 116 or by other means such as buttons or hook-and-loop fasteners. The compartments 115 can hold lotion, sunglasses, keys, or items that can be lost.

Further, the system 10 can also include a plurality of stake holes 117 for placing stakes into the ground to secure the playing surface 100. The stake holes 117 can be configured with bottle openers, as illustrated in FIG. 3. In this example, the stake holes 117 are located near the corners of the first end 101 of the playing surface 100. Additional holes 117 can be located at other locations such as the second end 104 of the playing surface 100.

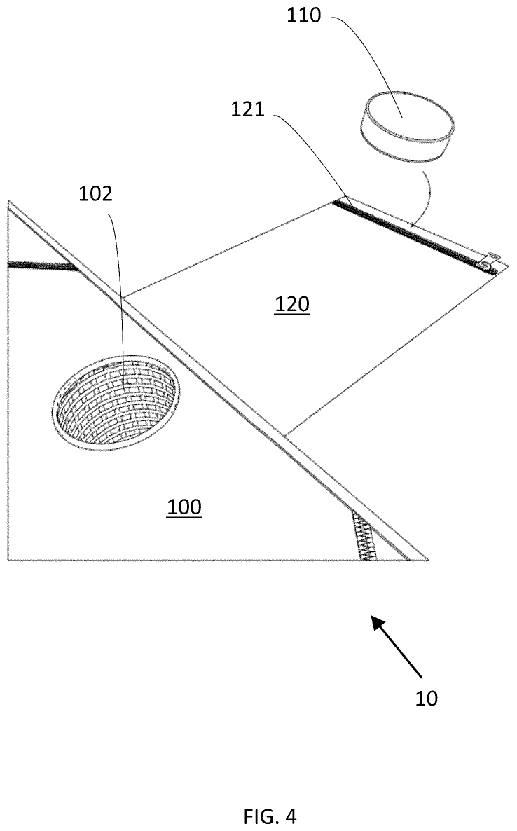

FIG. 4 illustrates a cross-sectional view of the system 10 showing an example use of the attached storage pouch 120. The storage pouch 120 is operatively connected (e.g. affixed, stitched) to an end (101 or 104) of the playing surface 100. The storage pouch 120 can be opened and closed using a zipper 121 or by other means such as buttons or hook-and-loop fasteners. The playing surface 100 can also be used as a towel for a user to sit or lay on. When a user wants to use the system 10 as a towel rather than a game, the bags 110 can be stored in the storage pouch 120. The user can flip the storage pouch 120 to position it on the playing surface 100 and cover the holes. The pouch 120 filled with bags 110 can be used as a comfortable pillow for a user to rest on.

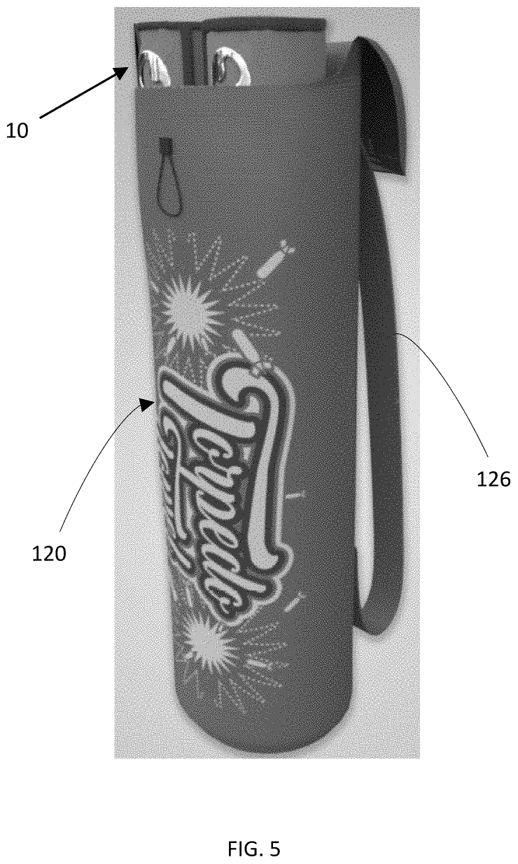

FIG. 5 illustrates a carry pouch 125 for storing and transporting the system 10. The playing surface 100 can easily be rolled up and placed in the carry pouch 125. The carry pouch 125 can include a handle 126 enabling a user to readily carry the system 10 by hand or over the user's shoulder.

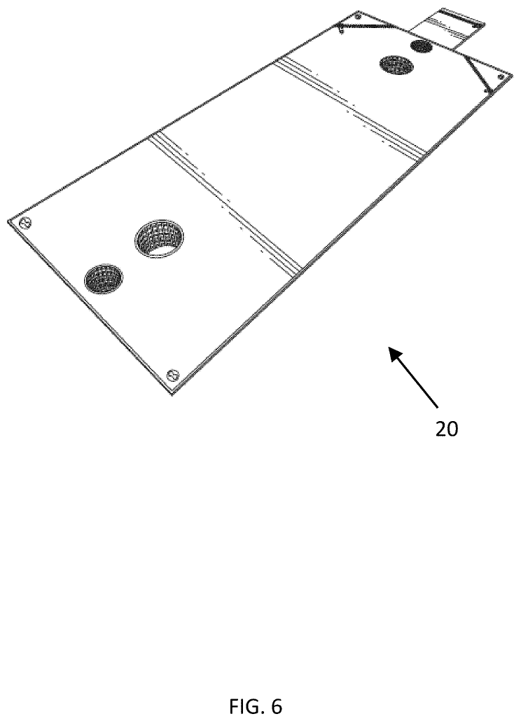

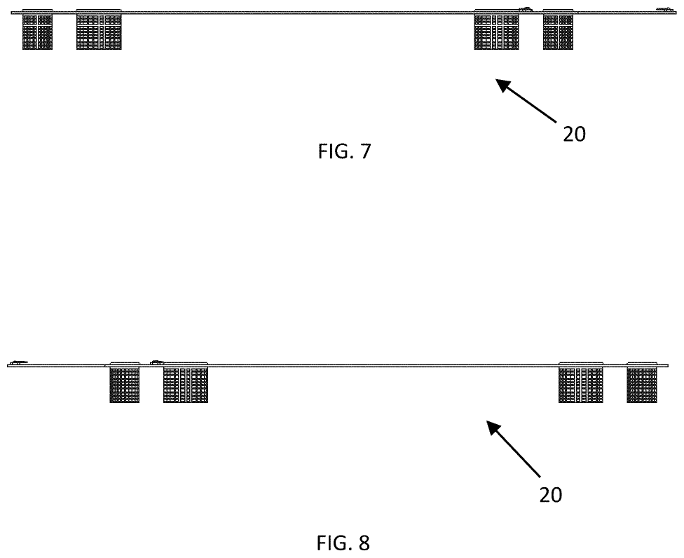

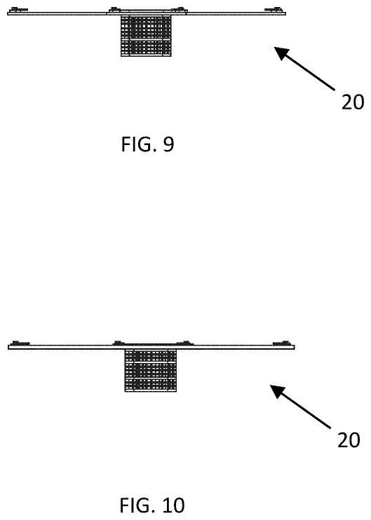

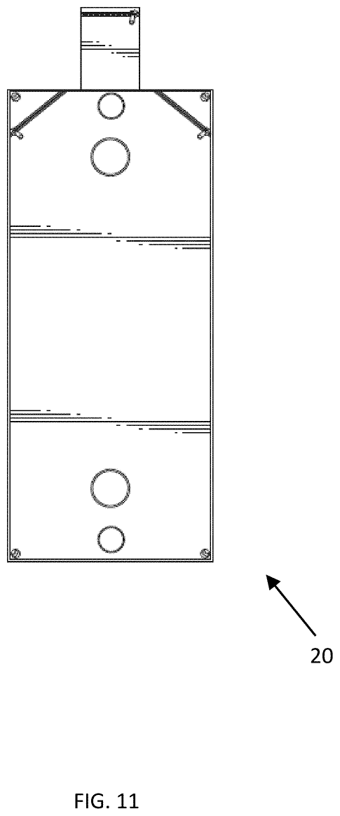

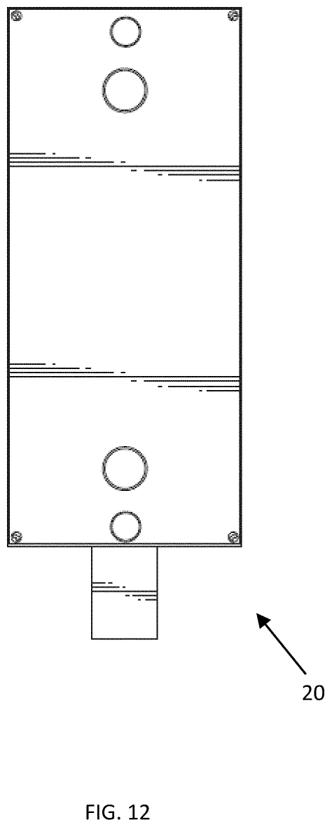

FIG. 6 illustrates a perspective view of an apparatus 20 without showing the bags used for games. The apparatus 20 is shown as a single body comprising the aforementioned components. FIG. 7 illustrates a right side view of the apparatus 20. FIG. 8 illustrates a left side view of the apparatus 20. FIG. 9 illustrates a front view of the apparatus 20. FIG. 10 illustrates a rear view of the apparatus 20. FIG. 11 illustrates a top view of the apparatus 20. FIG. 12 illustrates a bottom view of the apparatus 20.

1. A portable system comprising:
a. a playing surface comprising a first end and a second end;
b. wherein the playing surface is rollable;
c. a storage pouch affixed to the first end of the playing surface;
d. wherein the first end includes at least one hole;
e. wherein the second end includes at least one hole; and
f. a plurality of bags.

2. The portable system of claim 1, further comprising a carry pouch.

3. The portable system of claim 1, wherein the playing surface comprises a towel.

4. The portable system of claim 1, wherein:
a. the first end further includes at least one net affixed to the playing surface; and
b. the second end further includes at least one net affixed to the playing surface.

5. The portable system of claim 1, wherein the storage pouch is configured to store the plurality of bags.

6. The portable system of claim 1, further comprising at least one storage compartment.

7. The portable system of claim 1, further comprising a plurality of stake holes.

8. The portable system of claim 7, wherein the stake holes include bottle openers.

9. A portable system comprising:
g. a playing surface comprising a first end and a second end;
h. wherein the playing surface is rollable;
i. a storage pouch affixed to the first end of the playing surface;
j. wherein the storage pouch is configured to store the plurality of bags;
k. wherein the first end includes at least one hole;
l. wherein the second end includes at least one hole;
m. a plurality of bags;
n. a carry pouch;
o. the first end further includes at least one net affixed to the playing surface;
p. the second end further includes at least one net affixed to the playing surface;
q. at least one storage compartment; and
r. a plurality of stake holes.

10. The portable system of claim 9, wherein the stake holes include bottle openers.

11. The portable system of claim 9, wherein the playing surface comprises a towel.
